(19) United States
(12) Patent Application Publication
(10) Pub. No.: US 2014/0359723 A1
(43) Pub. Date: Dec. 4, 2014

(54) COMPUTER PROGRAM, SYSTEM, AND METHOD FOR PROVIDING A USER ACCESS TO ELECTRONICALLY PROVIDED CONTENT

(71) Applicant: JNT Company, LLC, Manhattan, KS (US)

(72) Inventors: Jeffrey Scott Hake, Wamego, KS (US); Nathaniel Crawford, Olathe, KS (US)

(73) Assignee: JNT Company, LLC, Manhattan, KS (US)

(21) Appl. No.: 14/285,309

(22) Filed: May 22, 2014

Related U.S. Application Data
(60) Provisional application No. 61/828,967, filed on May 30, 2013.

(51) Int. Cl. H04L 29/06; A63F 13/73; A63F 13/79

(52) U.S. Cl. CPC H04L 63/08; A63F 13/79; A63F 13/73
USPC 726/5; 463/29

(57) ABSTRACT

A computer program, method, and system for providing a user access to content in response to an unprompted input or other triggering event at or on a user device. More particularly, the computer program, method, and system provide for the presentation of a masked access point to content. Upon the detection of an input by the user, if said input matches a predetermined access key, then the content is delivered to and/or retrieved by the user device.

### RELATED APPLICATION

This non-provisional patent application claims priority benefit, with regard to all common subject matter, of earlier-filed U.S. Provisional Patent Application No. 61/828,967, filed May 30, 2013, and entitled “COMPUTER PROGRAM, SYSTEM, AND METHOD FOR PROVIDING A USER ACCESS TO ONLINE CONTENT.” The identified earlier-filed provisional patent application is hereby incorporated by reference in its entirety into the present application.

### FIELD

Embodiments of the invention are directed to a computer program, system, and method for providing a user access to content in response to an unprompted input. More particularly, embodiments of the invention are directed to providing a user access to electronically provided content by listening for a predetermined unprompted input or other triggering event at or on a user device.

### BACKGROUND

Electronically provided content is used for various aspects of everyday life such as e-commerce, social media, entertainment, blogging, and academics. As methods of online access evolve, and as bandwidth increases, new types of content become available to users. However, the effectiveness and desirability of content is limited by the ease of content accessibility.

Some electronically provided content is intended to be access-limited, accessible only by select individuals with proper authorization. Known methods of access prevention present vulnerabilities and often inhibit effective use by select individuals.

### SUMMARY

Embodiments of the invention provide for a method, a system, and a computer program directed to providing a user access to content in response to an unprompted input or other triggering event at or on a user device. Embodiments include the initial step of presenting on a user device a masked access point to the content. An input is detected from a user interface of the user device, and in embodiments, the input is an unprompted input. Upon receiving the unprompted input, the unprompted input is compared to a predetermined key uniquely associated with the content. Embodiments of the invention then determine if the unprompted input matches the predetermined key associated with the content. If the comparison determines that the unprompted input matches the predetermined key, then the content is identified as being deliverable to the user, e.g., the content is “flagged”. Finally, the content is instructed to be presented to the user device. Embodiments may be applicable to client-side retrieval of URLs based on keywords or the general retrieval of online content from a masked access point.

Embodiments additionally include the step of transmitting the unprompted input over a network to a remote device hosting the content online. Additional steps include transmitting the content to the user device over the network. Such embodiments may be applicable to server-side comparison or verification of the predetermined key and delivery of the content to the user device.

Other embodiments of the invention may include a listener function on either the user device or the remote device for actively seeking the unprompted input. In the event a user is also presented with a traditional input box at the masked access point, and the user selects the traditional input box for the traditional access method, the listener can be temporarily disabled until the traditional input box is no longer the actively selected element (highlighted), or if the user proceeds with the traditional access method.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

### BRIEF DESCRIPTION OF THE DRAWINGS

Further features of the invention will become apparent to those skilled in the art to which the invention relates from reading the following description with reference to the accompanying drawings, in which:

FIG. 1 is a schematic depiction of a system for providing a user access to online content in accordance with an embodiment of the invention;

FIG. 2 is a flow chart of a method for providing a user access to content according to one embodiment of the invention; and

FIG. 3 is a flow chart of a method for providing a user access to content according to an alternative embodiment of the invention.

The drawing figures do not limit the invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

The invention provides various embodiments of a computer program, a method, and a system for providing a user access to content in response to an unprompted input at or on a user device. In more detail, embodiments of the invention may be implemented to allow content providers on various mediums (i.e., web sites, mobile applications, television shows, video games, movies, virtual worlds, and other content presented on electronically-based media consumption devices) to present a user with a masked access point to online content, detect an input from the user, and present the user with the content associated with the input if such an association exists.

As used herein, a masked access point is generally defined as a graphical representation of an access point to content, operable to listen to an input from a user, wherein the graphical representation does not necessarily present a traditional key input or a visible prompt for user input. The masked access point cannot be inspected or searched for, or otherwise reverse engineered to obtain the input that a user should provide to access the content. This is opposite to, for example, websites having associated source code that a browser, and thus a user, can inspect and read. In some embodiments, a traditional key input or visible prompt for user input may still be presented while the access point is still operable to listen to an input from the user. Other embodiments may disable the listener while the traditional key input is highlighted or selected by the user, as discussed further below.

As used herein, a traditional key input is, for example, a field or box that is displayed on a graphical user interface (GUI) and in which the user inputs information, or provides an instruction. For example, in the case where the user is accessing a secure resource, such as the user's online banking account, the traditional key input comprises username and password fields or boxes. The user inputs their username and password to access the secure resource, i.e., the online banking account. In embodiments of the invention, however, and as discussed below, the traditional key input is not presented to the user on the GUI unless and until the user provides the unprompted input at the masked access point. Only upon providing the unprompted input at the masked access point will the user either be granted access to the secure repository or, in embodiments, be presented with the traditional key input of the username and password fields. Another exemplary traditional key input is a URL to a content management system (CMS). The user must know the exact URL to access the CMS. Thus, typing the correct URL in an address bar of an Internet browser will retrieve specific content, namely the CMS, such that the address bar is a traditional key input for receiving the URL. In embodiments of the invention, however, the CMS is not retrievable via the address bar and a URL and is instead only retrievable by supplying a predetermined key at a masked asked point.

It is appreciated that the terms “content” and “online content” refer to content provided by electronic devices including, but not limited to, web browsers, web-based software, local client software, apps, cell-phones, smart phones, wearable computing devices, video players, music players, game players, and printers. The content provided therein may be supplied in an online format such as a webpage or a message or may be stored locally. The content need not necessarily be stored at a remote device and transmitted over a network. For example, content could be encrypted and stored locally on a set-top box in a user's living room. The set-top box provides a masked access point to receive an unprompted input. Upon the user successfully inputting a secret, predetermined key, the set-top box provides the content locally by unencrypting it and displaying it to the user.

Embodiments of the invention may be adapted to operate primarily on the user device, so that users can provide an input at the masked access point, and the user device can retrieve the user's desired content based on content defined or otherwise associated with a predetermined key that matches the input. As a non-limiting example, a web browser may be configured with a listener that runs in the background while displaying any website. The user may type in a name of one of the creators of the web browser at any time during their web-browsing session. When the listener detects an input string that matches the name of one of the web-browser creators, the listener is operable to trigger a function to display a screen in the web browser with a special message to the user. Other embodiments may utilize a keyword trigger to provide access to a predetermined URL displaying a promotional offer via a previously non-displayed website on the Internet. In some embodiments, if the traditional address bar on the browser is selected for traditional keyed input from the user, the listener may be temporarily disabled until the address bar is no longer active to receive user input (highlighted).

Other embodiments of the invention may be adapted to operate between a user device on the client-side, and a remote device on the server-side. In such an embodiment, a remote device may present a masked access point for display on the user device, and the user device can retrieve the user's desired content based on content defined with a predetermined key that matches the input. For example, in one embodiment, a web page that requires authorized access to view sensitive information may not present to the user a login box or prompt. However, the web page may be configured to listen to unprompted inputs from the user. As unprompted inputs are detected by the user device, they are sent to the remote device for comparison to known predetermined keys. In the event a match is determined for the input and the predetermined key, the content associated with the matching predetermined key is flagged for delivery to the user device. As used herein, when content is flagged, the system programmatically determines that the content is the user's desired content. Embodiments may actually modify metadata to a file to flag it. Other embodiments may build a list or database to keep track of flagged files. Even further embodiments may not alter any files at all, but either keep track in memory that a match has been made and that at least one file is queued for retrieval or delivery, or may simply process the at least one file (i.e., send to the user device, or retrieve the URL).

Another embodiment of the invention may provide content providers with the ability to send at least one cookie or a plurality of cookies, also known as HTTP cookies, web cookies, or browser cookies, to the user device in the event of a matching unprompted input. In some embodiments, a cookie received on a user device may be operable to provide that particular user or user device with preauthorized access to online content.

Other embodiments of the invention may incorporate user devices that do not use traditional input methods, such as touch screen tablets, smart phones, accelerometer-based controllers, IR-based pointers, and other motion or touch-based input devices. Embodiments may use computer programs and algorithms to determine whether the inputs detected by these devices are sufficient to establish a statistical match to the predetermined key due to the low probability that a direct match is established. For example, if a predetermined key is the shape of a dollar sign, the user's input using any of the nonconventional devices is extremely unlikely to establish an exact match to the predetermined dollar sign key. A programmed logic may be implemented so that, based on the user's input, an analysis is performed on the input and a match is determined based on a percentage of likeness to the predetermined key.

Embodiments of the invention may implement the listener functionality through software preinstalled on the client, software sent to the client from a remote device, or software installed on the remote device capable of listening to inputs from the user device through a network. In one embodiment, a listener may be integrated into a software application's code. Other embodiments may include listener functionality in the form of a plug-in, extension, or aftermarket modification. Even further embodiments may send the listener to a user device in response to an HTTP request, similar to a Java applet, JavaScript, or an ActiveX application. Remote devices may also send a form of script or command to automatically launch a preinstalled listener on the user device, wherein if such a listener is not installed, the option to install it may be presented to the user. The listener may be broken up into multiple components to achieve the functionality intended for listening to an input and performing an action based on the input. Embodiments may distribute the various components amongst one or several computing devices, locally or remotely, to achieve the same functionality intended of the listener. Some embodiments of the listener may override known functionalities of the applications they are listening from. For example, hot keys could potentially be associated with functions in a web browser. When a web page utilizing a listener is loaded, the listener may disable or override the hot key functions while listening to user inputs.

Some embodiments of the invention may be operable to navigate a webpage. For example, the content management system (CMS) described above may require that an administrator log in before any content changes are made. The listener may be operable to detect a predetermined key at any location of the website to access the administrative login page, or even to access the administrative page itself. Other embodiments could further incorporate redirects from within a website to access various pages or portions of a webpage associated with a predetermined key. Such embodiments could eliminate the need for clear-text URLs delivered in HTTP requests that could potentially pose a security threat. Embodiments that incorporate a secured listener could potentially eliminate concerns of clear-text transmissions by encrypting inputs from the client device and transmitting them to the remote device for decryption and comparison to a predetermined key. Methods of encryption from the listener to the remote device may use any Internet client-server based standards of secured transmission, such as HTTPS, SSL, SFTP, TLS, or SSH. Encryption methods may use any form of hashing, symmetric, or public key encryption.

Embodiments of the invention may be also adapted to provide users with an online shopping experience, wherein the input provided by the user allows the user to obtain discounts or additional items at no charge. As a non-limiting example, the user would provide an input while viewing an online shopping website. The input is then compared to a predetermined key associated with online content. If the user input matches the predetermined key, then the price of items available for purchase at the shopping website is automatically altered (e.g., lowered). The input could be learned by the user in response to certain marketing methods (e.g., the user visiting the shopping website a minimum number of times) or could be unintuitive, such as the user of the shopping website typing the words “charge me more” into a computer keyboard to keep everyone from obtaining the discount on online content. In embodiments of the invention, the input may be intuitive such as users of the shopping website typing the word “sale” when a company that sells products via the shopping website is trying to use the keyword as a marketing technique. As can be appreciated, various marketing techniques may be used to create a viral use of the unprompted input.

Embodiments of the present invention may be also adapted to provide users with an online shopping experience, wherein the input provided by the user is indicative of actions that the user perceives as standard online shopping actions (such as adding or deleting a product from a shopping cart). When the unprompted input is received by the remote device, it is compared to a predetermined key associated to an online content, and the online content is said product's relationship to the shopping cart. As a non-limiting example, a user visiting a virtual shopping mall may wish to purchase an item displayed on the user device's display. The user may provide an input, such as a slashing motion with his/her user device, to add the item into the shopping cart. Embodiments may be adapted to provide the user with a variety of intuitive motions to simplify their virtual online shopping experience, wherein each motion or collection of motions is equivalent to an input to be compared with a predetermined key.

In embodiments of the invention, the computer program instructs a processor to perform the following steps: present to a user a masked access point to content on at least one display; detect an unprompted input from a user interface of the user device; compare the unprompted input to a predetermined key uniquely associated with the content, wherein if the unprompted input matches at least one of the predetermined keys uniquely associated with the content, then said content is identified as being available to be presented to the user; and instructing presentation of the content on the user device. The computer program of the invention instructs a processor to perform the method of the invention, and the system of the invention comprises at least one computing device having a memory and a processor for performing the above steps.

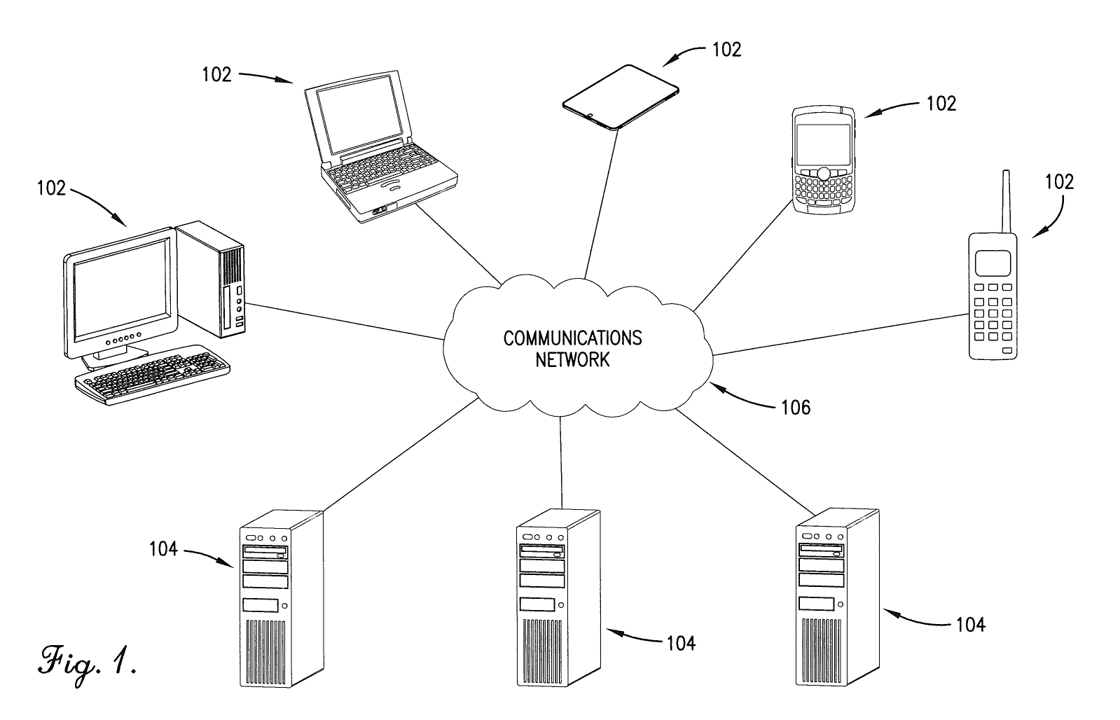

As depicted in FIG. 1, the invention embodied in a system 100 may comprise computing devices 102, servers, databases, and communications networks 106 to facilitate the functions and features described herein. The computing devices 102 and servers 104 may comprise any number and combination of processors, controllers, integrated circuits, programmable logic devices, or other data and signal processing devices for carrying out the functions described herein, and may additionally comprise one or more memory storage devices, transmitters, receivers, and/or communication busses for communicating with the various devices of the system. In various embodiments of the invention, the computing devices may comprise a memory element, a communication component, a display, and/or a user interface.

The computing devices may include any device, component, or equipment with a processing element and associated memory elements. The processing element may implement operating systems, and may be capable of executing the computer program, which is also generally known as instructions, commands, software code, executables, applications, apps, and the like. The processing element may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. In certain embodiments, the computing device will have an electronic display, such as a cathode ray tube, liquid crystal display, plasma, touch screen, LED, or other electronic display that is operable to display visual graphics, images, text, etc. In certain other embodiments, the computer program of the invention facilitates interaction and communication through a graphical user interface (GUI) that is displayed via the electronic display. The GUI enables the user to interact with the electronic display by touching, pointing, or otherwise selecting display areas to provide information to the user interface, discussed in more detail below.

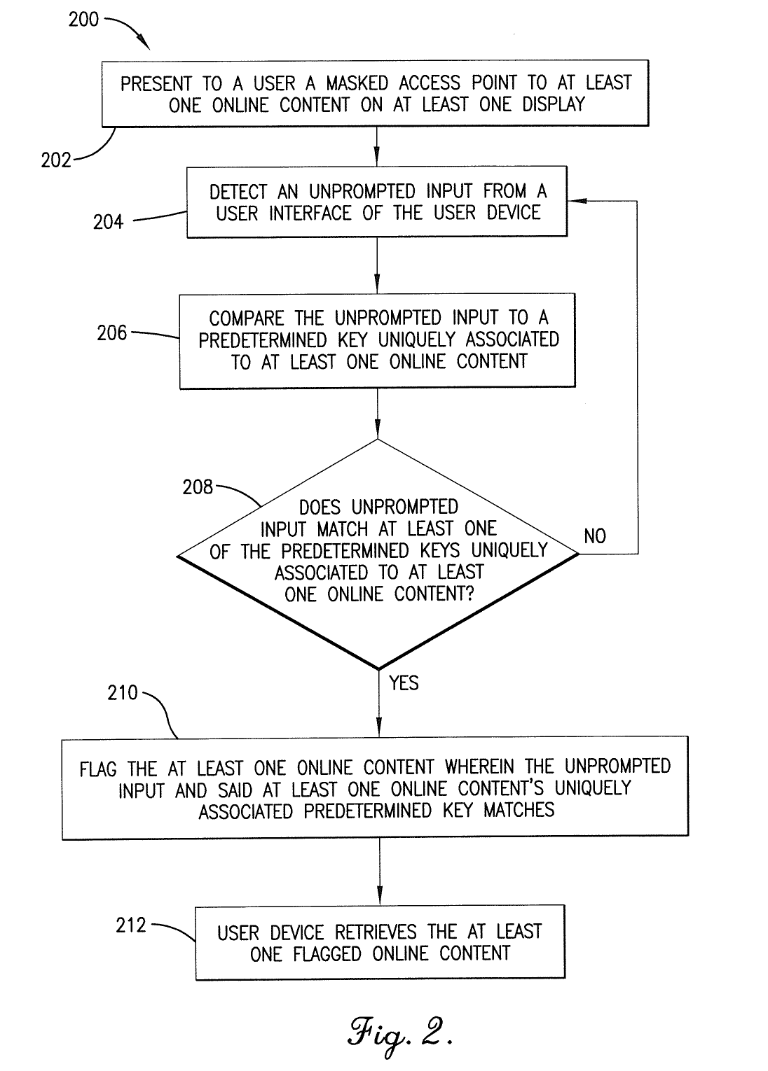

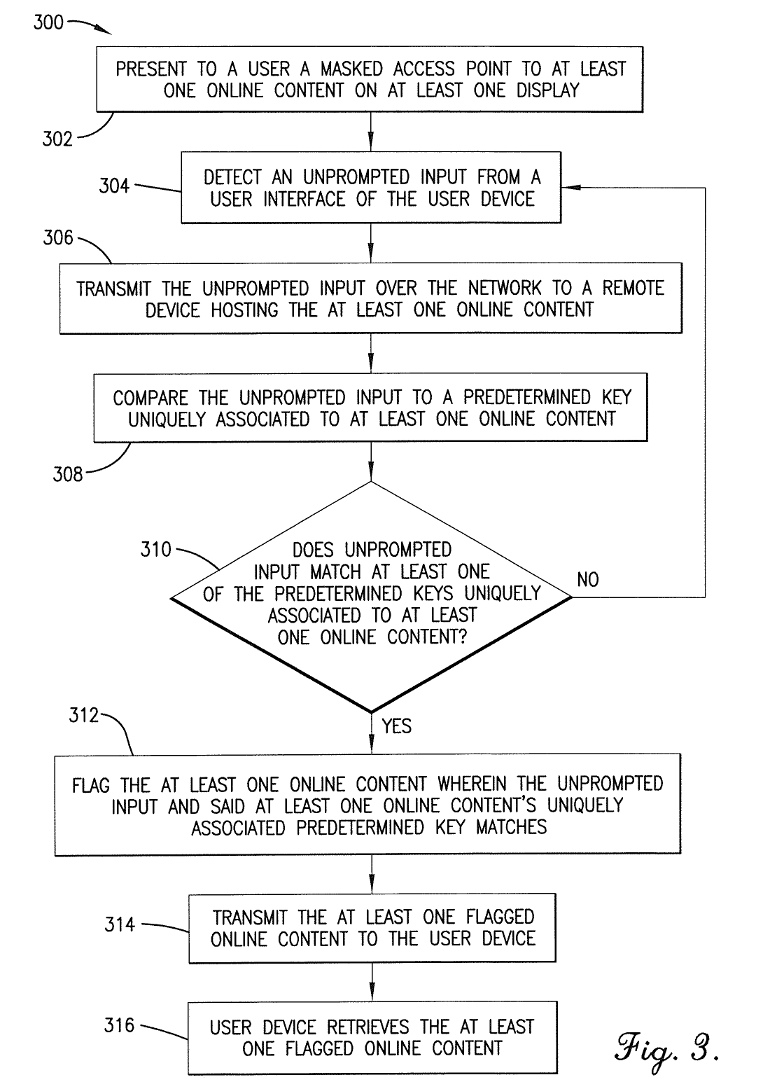

In embodiments of the invention, the computing devices 102,104 and/or databases may implement the computer program and/or code segments of the computer program to perform the steps of the method of the invention described herein. The steps of the method may be performed in the order shown in FIG. 2, or they may be performed in the order shown in FIG. 3, or they may be performed in a different order, unless otherwise expressly stated. Furthermore, some steps may be performed concurrently as opposed to sequentially. Also, some steps may be optional. The computer program may comprise a listing of executable instructions for implementing logical functions in the user device.

The computer program can be embodied in any computer readable medium for use by or in connection with an instruction execution system, apparatus, or device, and execute the instructions. In the context of this application, a “computer readable medium” can be any means that can contain, store, communicate, propagate, or transport the program for use by or in connection with the instruction execution system, apparatus, or device. The computer readable medium can be, for example, but not limited to, an electronic, magnetic, optical, electro magnetic, infrared, or semi conductor system, apparatus, device or propagation medium. More specific, although not inclusive, examples of the computer readable medium would include the following: a portable computer diskette, a random access memory (RAM), a read only memory (ROM), an erasable, programmable, read only memory (EPROM or flash memory), and a portable compact disk read only memory (CDROM), and combinations thereof. The various actions and calculations described herein as being performed by or using the computer program may actually be performed by one or more computers, processors, or other computational devices, such as the described herein, independently or cooperatively executing portions of the computer program. The functionality of the computing devices 102,104 may also be distributed amongst many different computers 104 in a cloud computing environment.

The user device 102 can be any form of computing device, such as a desktop computer 102, laptop 102, tablet 102, smartphone 102, video game console 102, television, personal GPS device, or automobile on-board computer. The user device 102 includes a user interface for receiving a user input, such as a button or buttons, keyboard, keypad, mouse, remote control, video game controller, microphone, accelerometer, or touch screen. The user interface may enable one or more users to share information and commands with the computing devices 102,104. The user interface may comprise one or more functionable inputs such as buttons, keyboard, switches, scroll wheels, voice recognition elements such as a microphone, pointing devices such as mice, touchpads, tracking balls, and styluses. The user control interface may also include a speaker for providing audible instructions and feedback. Further, the user interface may comprise wired or wireless data transfer elements, such as a communication component, removable memory, data transceivers, and/or transmitters, to enable the user and/or other computing devices to remotely interface with the computing devices 102,104.

The communications network 106 may be wired or wireless and may include servers, routers, switches, wireless receivers and transmitters, and the like, as well as electrically conductive cables or optical cables. The communications network 106 may also include local, metro, or wide area networks, as well as the Internet, or other cloud networks. Furthermore, the communications network 106 may include cellular or mobile phone networks, as well as landline phone networks, public switched telephone networks, fiber optic networks, BLUETOOTH, or other wireless local area networks, or the like.

The user device 102 may include a “listener” for actively seeking the unprompted input. The user device may also include circuitry and/or computer code for triggering a programmed event or procedure, such as generating a signal, request, or command to be sent to a remote device. Alternatively, the listener, and/or the circuitry, and/or computer code for triggering the programmed event or procedure may be hosted by the remote device 104. Upon detecting the unprompted input, the listener triggers the programmed event or procedure.

The listener can be disabled in certain instances, such as when a user is utilizing a traditional key input, e.g., a username/password text box. In such an embodiment, if the GUI is presenting a traditional key input, or if the computer program otherwise determines that the user is utilizing a traditional key input, then the listener and associated functions may be disabled or otherwise prevented from being activated for a pre-set period of time. Such pre-set period of time may be a certain elapsed time, e.g., thirty seconds, or may be for the period of time that the traditional key input is presented on the GUI, in focus on the GUI, or otherwise being utilized by the user.

Embodiments of the listener may be implemented with a variety of methods, such as Java, ActiveX, HTML, web-browser plugins, or as an “always-on” listener that runs in the background of the running application or even the operating system. The listener may be installed independently from the client side, or may be remotely installed to the user device from the remote device. Some embodiments may implement the listener to run purely on the remote device 104, while the user device 102 continuously transmits the user inputs over the network 106 to the remote device listener.

The user device 102 includes circuitry and/or computer code for transmitting the signal, request, command, or other data to the remote device 104 over a network 106 for retrieving the online content. The circuitry may include a modem, router, antenna, wireless transmitter, or other components for connecting to a network. The user device may also be configured to receive the online content from the network and may further include a display screen for displaying the online content. The display screen may also be the touch screen for receiving the unprompted input. Alternatively, the online content may be sent to a second device. The user device may include a memory for temporarily storing user data related to the unprompted input, such as a “cookie” for signifying that the input has been previously provided before and that the online content should be made available.

The remote device 104 is a computing device that may be a desktop computer, laptop, tablet, smartphone, server, or other device capable of hosting content and connecting to the communications network 106 and may include the listener and for seeking the unprompted input and circuitry and/or computer code for triggering the programmed event or procedure. The network 106 may be the internet, an intranet, or a telecommunications network.

Both the remote devices 104 and the user devices 102 may be connected to the communications network 106. Remote devices 104 may be able to communicate with other remote devices 104 or user devices 102 through the communications network 106. Likewise, user devices 102 may be able to communicate with other user devices 102 or remote devices 104 through the communications network 106. The connection to the communications network 106 may be wired or wireless. Thus, the remote devices 104 and the user devices 102 may include the appropriate components to establish a wired or a wireless connection.

The computer program of the invention may run on one or more computing devices, remote devices or, alternatively, may run on multiple user devices. In additional embodiments, a first portion of the program, code, or instructions may execute on a first remote device or a first user device, while a second portion of the program, code, or instructions may execute on a second remote device or a second user device. In some embodiments, other portions of the program, code, or instructions may execute on other remote devices as well. For example, information may be stored on a memory element associated with the remote device, with such information being remotely accessible to users of the computer program via one or more user devices. Alternatively, information may be directly stored on the memory element associated with the one or more computing devices of the user. In additional embodiments of the invention, portions of information related may be stored on the remote device, while other portions may be stored on the one or more computing devices. The various actions and calculations described herein as being performed by or using the computer program may actually be performed by one or more computers, processors, or other computational devices, such as the computing devices, user devices and/or remote devices, independently or cooperatively executing portions of the computer program.

In certain embodiments of the invention, portions of the computer program may be embodied as a stand-alone program downloaded on a user's computing device or in a web-accessible program that is accessible by the user's computing device via the network, each of which being functional to access an electronic resource. For the stand-alone program, a downloadable version of the computer program may be stored, at least in part, on the remote device. A user can download at least a portion of the computer program onto the user device via the network. In such embodiments of the invention, the computer program may be an “application,” such as an “app” for a mobile device. After the computer program has been downloaded, the program can be installed on the user device in an executable format. The executable form of the program permits the user to access embodiments of the invention via the electronic resource, such as a mobile “app” or website. For the web-accessible computer program, the user may simply access the computer program via the network (e.g., the Internet) with the user device.

The content may be a website, page or section of a website, content management system (CMS), electronic file or document, database, pop-up, window, menu, command prompt, shortcut, link, action, coupon, discount data, embedded media, user preferences, product information, shopping carts, product lists, or other content. The content may be initially hidden, encrypted or otherwise secure, un-editable, disabled, or inconveniently or indirectly accessible. The content may be revealed, decrypted, made editable, enabled, more easily or directly accessed, purchased, downloaded, or changed when the user provides the unprompted input.

The unprompted input may be the press of a button or key, virtual button (including invisible or hidden virtual buttons), a swipe, gesture, motion, sound, spoken word, or any combination or plurality of the above inputs. An unprompted input combination may represent a user's personal identification number (PIN), a secret phrase, a series of swipes such as strokes forming a letter or symbol on a touch screen, or a series of motions such as shaking a controller and waving it back and forth.

The computer program of the invention provides for an instructing of a processor to perform an initial step of presenting to a user a masked access point to content 202. Embodiments may present the access point on at least one display of a computing device, wherein the masked access point enables a listener that detects inputs from a user. The enabling of the listener may be discrete or announced to the user through audio or visual notifications. The user may have some knowledge on how to enter the masked access point, or may have been provided with training on how to enter the masked access point. Other embodiments of the computer program may provide for an intuitive interface so that a user may understand that a masked access point is provided.

The computer program continually detects an input from the user interface of the user device 204. The computer program instructs a processor to compare the inputs from the user interface to a predetermined key uniquely associated to content 206. The logic to compare the inputs from the user interface and the predetermined keys uniquely associated to the content 206 are encrypted, hashed, obfuscated, or otherwise unable to be reverse engineered by the user. Unlike typical source code, the comparison of the unprompted input from the user interface to a predetermined key uniquely associated with the content 206 is performed on a secondary device or through a set of encrypted or otherwise obfuscated section of memory on the device that provides the masked access point. In the event the computer program's instructions to the processor determines that a match is made to a predetermined key uniquely associated with the content 208, the computer program instructs the processor to flag that particular content for further action 210. If the computer program's instructions to the processor do not determine a match to a predetermined key 208, it instructs the processor to continue processes that listen for inputs from the user device 204.

The logic behind determining a match can be implemented by a variety of algorithms. For example, in one embodiment, an exact match with no extraneous inputs before or after the predetermined key would establish a match. Another embodiment may search through an entire string of inputs and determine whether the predetermined key is wholly contained within the string. Other embodiments may only establish a match only when comparing the last inputs within a string of inputs, before a terminating signal such as a carriage return, while ignoring extraneous inputs prior to the beginning of the matching predetermined key. The computer program instructs the processor to retrieve the content that was flagged for further action 212, as described in Step 210.

In another embodiment as described in FIG. 3, typically in a client/server environment, the computer program of the invention provides for an initial step of instructing the processor to present a user with a masked access point to content 302. As noted above, the user may be have some knowledge as to how to enter the masked access point, or may have been provided with training on how to enter the masked access point. Other embodiments may provide for an intuitive interface so that a user may understand that a masked access point is provided. The computer program then instructs the processor to continually detect an input from the user interface of the user device 304. The computer program will then instruct the processor to transmit the inputs, either in real-time or after a line terminating signal such as a carriage/cartridge return, to a remote device hosting further components and processes of the computer program 306. The computer program instructs the processor to compare the inputs from the user interface to a predetermined key uniquely associated with the content 308. In the event the computer program's instructions to the processor determines that a match is made to a predetermined key uniquely associated with the content 310, the computer program instructs the processor to flag that particular content for further action 312. If the computer program's instructions to the processor do not determine a match to a predetermined key 310, it instructs the processor to continue processes that listen for inputs from the user device 304. The logic behind determining a match can be implemented by a variety of algorithms. For example, in one embodiment, an exact match with no extraneous inputs before or after the predetermined key would establish a match. Another embodiment may search through an entire string of inputs and determine whether the predetermined key is wholly contained within the string. Other embodiments may only establish a match only when comparing the last inputs within a string of inputs, before a terminating signal such as a carriage return, while ignoring extraneous inputs prior to the beginning of the matching predetermined key. The computer program instructs the processor to transmit the flagged online content to the user device 314. The computer program instructs the processor to retrieve the content that was flagged for further action 316, as described in Step 312, and transmitted in Step 314.

Although this invention has been described with its preferred embodiment(s), it is noted that equivalents may be employed and substitutions made herein without departing from the scope of the invention.

Having thus described various embodiments of the invention, what is claimed as new and desired to be protected by Letters Patent includes the following:

1. A method for providing access, on an electronic user device, to at least one item of content, the method comprising the steps of:
presenting, by at least one processing element and on the user device, a masked access point to said at least one item of content;
detecting, by at least one processing element, an unprompted input from a user interface associated with the user device,
wherein the unprompted input is detected during the presentation of the masked access point;
comparing, by at least one processing element, the unprompted input to a predetermined key uniquely associated with said at least one item of content;
determining, by at least one processing element, that the unprompted input matches the predetermined key uniquely associated with said at least one item of content;
in response to the determination that the unprompted input matches the predetermined key uniquely associated with said at least one item of content, identifying, by at least one processing element, said at least one item of content as available to be presented to the user; and
instructing, by at least one processing element, presentation of said at least one item of content on the user device.

2. The method of claim 1, further including the steps of:
establishing, by at least one processing element, a predefined input box associated with the at least one item of content for display on the user device;
receiving, by at least one processing element, information indicative of the predefined input box being in focus on the user device;
in response to the predefined input box being in focus on the user device, ceasing the step of detecting the unprompted input.

3. The method of claim 2, wherein the step of ceasing the step of detecting the unprompted input is for either a pre-set period of time or for a period of time generally commensurate with the predefined input box being in focus on the user device.

4. The method of claim 1, wherein the at least one item of content is a cookie.

5. The method of claim 1, wherein the at least one item of content is a specific product's relationship to a shopping cart.

6. The method of claim 1, wherein the presentation of the masked access point is in a video game, and the item of content is related to the video game.

7. The method of claim 1, wherein the at least one item of content is a user's authentication credentials for accessing a secure resource, and the user's authentication credentials are only retrievable by the user by inputting the unprompted input during the presentation of the masked access point.

8. The method of claim 1, wherein the step of instructing presentation of said at least one item of content on the user device includes the step of instructing a third party to present said at least one item of content on the user device.

9. A non-transitory computer readable storage medium with an executable program stored thereon for providing access, via a user device, to at least one item of content, wherein the program instructs at least one processing element to perform the steps of:
presenting, on the user device, a masked access point to said at least one item of content;
detecting an unprompted input from a user interface associated with the user device,
wherein the unprompted input is detected during the presentation of the masked access point;
comparing the unprompted input to a predetermined key uniquely associated with said at least one item of content;
determining that the unprompted input matches the predetermined key uniquely associated with said at least one item of content;
in response to the determination that the unprompted input matches the predetermined key uniquely associated with said at least one item of content, identifying said at least one item of content as available to be presented to the user; and
instructing presentation of said at least one item of content on the user device.

10. The computer readable storage medium of claim 9, wherein the computer program further instructs the at least one processing element to perform the steps of:
establishing, by at least one processing element, a predefined input box associated with the at least one item of content for display on the user device;
receiving, by at least one processing element, information indicative of the predefined input box being in focus on the user device;
in response to the predefined input box being in focus on the user device, ceasing the step of detecting the unprompted input.

11. The computer readable storage medium of claim 10, wherein the step of ceasing the step of detecting the unprompted input is for either a pre-set period of time or for a period of time generally commensurate with the predefined input box being in focus on the user device.

12. The computer readable storage medium of claim 9, wherein the at least one item of content is a cookie.

13. The computer readable storage medium of claim 9, wherein the at least one item of content is a specific product's relationship to a shopping cart.

14. The computer readable storage medium of claim 9, wherein the presentation of the masked access point is in a video game and the item of content is additional content related to the video game.

15. The computer readable storage medium of claim 9, wherein the at least one item of content is a user's authentication credentials for accessing a secure resource, and the user's authentication credentials are only retrievable by the user by inputting the unprompted input during the presentation of the masked access point.

16. The computer readable storage medium of claim 9, wherein the step of instructing presentation of said at least one item of content on the user device includes the step of instructing a third party to present said at least one item of content on the user device.

17. A system for providing access to at least one item of content on a user device, comprising:
a client component; and
a server component configured to:
transmit to the client component a masked access point to at least one item of content;
receive from the client component an unprompted input;
compare the unprompted input to a predetermined key uniquely associated to at least one item of content, wherein if the unprompted input matches at least one predetermined key uniquely associated to the at least one item of content, then said at least one item of content is flagged; and
transmit to the client component the at least one flagged item of content;
wherein the client component is configured to:
receive from the server component a masked access point to at least one item of content;
present to the user the masked access point to the at least one item of online content;
detect n unprompted input from a user interface of the user device;
transmit to the server component the unprompted input; and
receive from the server component the at least one item of flagged content.

18. The system of claim 17, wherein the client component is further configured to stop detecting for an unprompted input for a duration while a traditional input box is in focus.

19. The system of claim 17, wherein the at least one item of content is selected from the group consisting of a cookie, a specific product's relationship to a shopping cart, and additional content related to a video game.

20. The system of claim 17, wherein the at least one item of content is a user's authentication credentials for accessing a secure resource, and the user's authentication credentials are only retrievable by the user by inputting the unprompted input during the transmission to the client component of the masked access point.
